(19) United States
(12) Patent Application Publication
(10) Pub. No.: US 2025/0125063 A1
(43) Pub. Date: Apr. 17, 2025

(54) PASSIVE APPARATUS FOR REDUCING FLOATING RADIOACTIVE MATERIAL IN CONTAINMENT BUILDING

(71) Applicant: FNC TECHNOLOGY CO., LTD., Yongin-si (KR)

(72) Inventors: Hyun Chul LEE, Hwaseong-si (KR); Min Beom HEO, Suwon-si (KR); Jung Jin BANG, Yongin-si (KR); Ki Wan JANG, Yongin-si (KR); Doo Yong LEE, Suwon-si (KR); Jae Seon CHO, Yongin-si (KR)

(73) Assignee: FNC TECHNOLOGY CO., LTD., Yongin-si (KR)

(21) Appl. No.: 18/395,664

(22) Filed: Dec. 25, 2023

(30) Foreign Application Priority Data
Oct. 17, 2023 (KR) 10-2023-0138312

(51) Int. Cl. G21F 9/02; B01D 53/04; B01D 53/86; B01J 19/24

(52) U.S. Cl. CPC G21F 9/02; B01D 53/0415; B01D 53/8671; B01J 19/249; B01D 2253/1122; B01D 2255/1021; B01D 2255/1023; B01D 2257/108; B01D 2257/202; B01D 2257/2068; B01D 2258/02; B01D 2259/40084; B01J 2219/2481

(57) ABSTRACT

Disclosed is an apparatus for reducing floating radioactive material in a containment building capable of reducing radioactive material in the event of a major accident in a containment building such as a nuclear power plant. A radioactive material reduction unit configured to reduce radioactive material in the air is provided upstream of a flow induction unit configured to induce an air flow through catalytic reaction with hydrogen in the air in the event of a major accident. The flow induction unit may have a replaceable modular form. The radioactive material reduction unit may include an adsorber module configured to remove gaseous radioactive material, such as iodine or an iodine compound. The adsorber module may have a replaceable modular form. In addition, the radioactive material reduction unit may further include an aerosol filter fixed to an inlet to remove particulate radioactive material.

### BACKGROUND OF THE INVENTION

### Field of the Invention

The present invention relates to an apparatus for reducing floating radioactive material in a containment building capable of reducing radioactive material in the event of a major accident in a containment building such as a nuclear power plant.

### Description of the Related Art

A passive autocatalytic recombiner (PAR) is an apparatus installed in a nuclear reactor building to prevent hydrogen explosion in a containment building in the event of a major nuclear reactor accident. When the concentration of hydrogen in the containment building increases, the passive autocatalytic recombiner (PAR) generates an air flow using heat generated through catalytic reaction hydrogen, thereby removing hydrogen while operating instantaneously without supply of external energy.

Meanwhile, a containment filtered venting system (CFVS) is used as an apparatus that reduces the release of radioactive material in the event of a major accident. This apparatus filters out radioactive material generated in the containment building in the event of a major accident and releases filtered air to the outside, thereby depressurizing the containment building and minimizing a risk caused by the release of the radioactive material.

In the event of a major accident, it is important for a relevant apparatus to operate for a sufficient period of time without supply of external energy. A passive apparatus capable of removing hydrogen and simultaneously removing radioactive material in a containment building in the event of a major accident is disclosed in U.S. Patent Application Publication No. US 2019/0348185 A1 published on Nov. 14, 2019. The apparatus includes a natural convection flow duct, in which a plurality of catalyst members configured to recombine hydrogen and oxygen included in a gas flow is disposed. The apparatus is capable of removing hydrogen while generating natural convection flow through catalytic reaction with hydrogen and removing iodine through adsorption by iodine filtering downstream of the generated natural convection flow. In this structure, radioactive material directly enters the natural convection flow duct and comes into contact with the catalyst, whereby radiation poisoning may occur, and therefore the lifespan of the catalyst may be shortened. In addition, the air may be heated through catalytic reaction with hydrogen, which is unfavorable for iodine filtering.

Meanwhile, catalytic reaction with hydrogen generates a natural convection flow, which is important in terms of radioactive material reduction efficiency. Korean Utility Model Registration No. 464123, filed by Korea Nuclear Engineering Co. and registered, discloses a passive autocatalytic recombiner having an improved flow generation structure. The passive autocatalytic recombiner includes a cover body having an inlet provided at a lower end thereof to allow air including hydrogen gas to be introduced therethrough, an outlet provided at three sides of an upper end thereof to allow the introduced air to be discharged therethrough, and a guide plate inclined from the three sides to the other side in order to guide an air flow to the outlet. A catalyst housing assembly, in which a honeycomb type catalyst is seated in order to remove hydrogen through reaction with the introduced hydrogen gas, is removably mounted to a lower end of the cover body. A roof plate configured to prevent liquid falling from above from being introduced into the cover body through the outlet is installed on the three sides in which the outlet is formed.

Korean Utility Model Registration No. 479307, filed by Korea Nuclear Engineering Co. and registered, discloses the structure of another catalyst body that may be employed in the passive autocatalytic recombiner. The disclosed catalyst body for hydrogen removal has a honeycomb-type cylindrical or hexahedral shape with a plurality of cells inside, each cell having a contact surface parallel to the flow direction of hydrogen. The section of each cell of the catalyst body may have any one of a wavy structure, a triangular structure, a quadrangular structure, or a hexagonal structure.

### SUMMARY OF THE INVENTION

It is an object of the present invention to provide an apparatus that operates without the supply of external energy in the event of a major accident at a nuclear power plant to reduce floating radioactive material in a containment building.

It is another object of the present invention to improve the radioactive material reduction efficiency of an apparatus that operates without the supply of external energy in the event of a major accident to reduce floating radioactive material in the containment building.

In an aspect to accomplish the above objects, a radioactive material reduction unit configured to reduce radioactive material in the air is provided upstream of a flow induction unit configured to induce an air flow through catalytic reaction with hydrogen in the air in the event of a major accident. In addition, the flow induction unit may have a replaceable modular form.

In another aspect, the flow induction unit may have a bed structure in which a catalyst is fixed to a porous substrate by impregnation.

In another aspect, the radioactive material reduction unit may include an adsorber configured to remove gaseous radioactive material. In addition, the adsorber may have a replaceable modular form.

In another aspect, the adsorber may have a bed structure in which an adsorbent is fixed to a substrate by impregnation.

In a further aspect, the radioactive material reduction unit may further include an aerosol filter fixed to an inlet to remove particulate radioactive material.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a passive floating radioactive material reduction apparatus according to an embodiment;

FIG. 2 is a front view of the passive floating radioactive material reduction apparatus according to the embodiment;

FIG. 3 is a right side view of the passive floating radioactive material reduction apparatus shown in FIG. 2;

FIG. 4 is a view exemplarily showing a receiving space of a housing in which an adsorber module is slidably received;

FIG. 5 is a perspective view showing the configuration of an adsorber module according to an embodiment;

FIG. 6 is a view illustrating an exemplary layout structure of adsorption plates in the adsorber module;

FIG. 7 is a perspective view showing the configuration of an adsorption plate according to an embodiment;

FIG. 8 is view exemplarily showing a receiving space of the housing in which a flow induction unit is slidably received;

FIG. 9 is a perspective view showing the configuration of a flow induction unit according to an embodiment; and

FIG. 10 is a perspective view showing the configuration of a catalyst plate according to an embodiment.

### DETAILED DESCRIPTION OF THE INVENTION

The foregoing and additional aspects are embodied in embodiments described with reference to the accompanying drawings. It is understood that components of each embodiment may be variously combined in the embodiment or may be variously combined with components of other embodiments, unless mentioned otherwise or mutually inconsistent. It should be understood that the terms or words used in the specification and appended claims should be construed based on meanings and concepts according to the technical idea of the present invention on the basis of the principle that the inventor can appropriately define the concept of terms in order to best describe their invention. Hereinafter, preferred embodiments of the present invention will be described in detail with reference to the accompanying drawings.

### Invention Defined by Claims 1 and 2

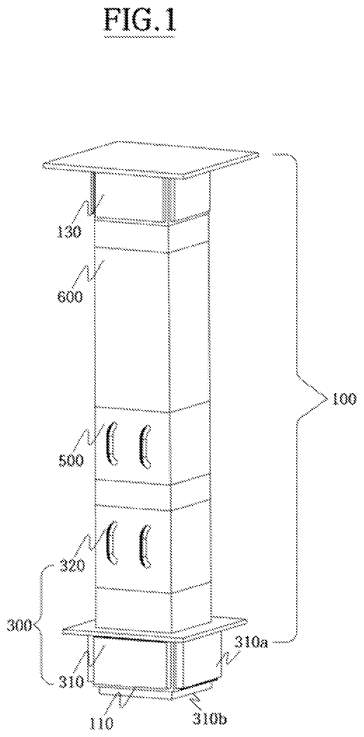

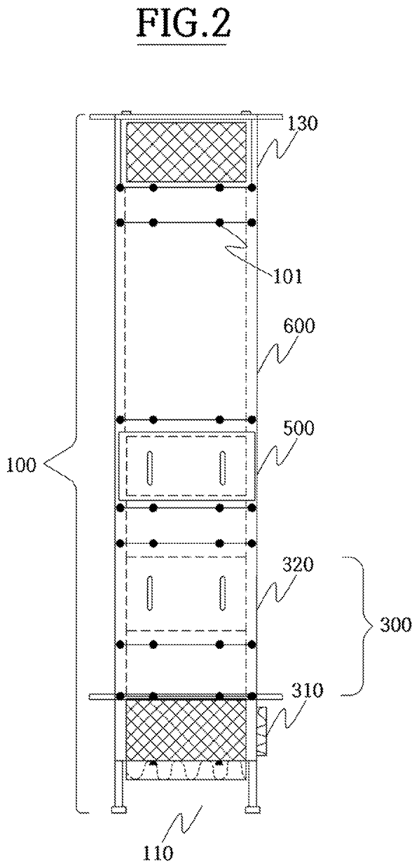

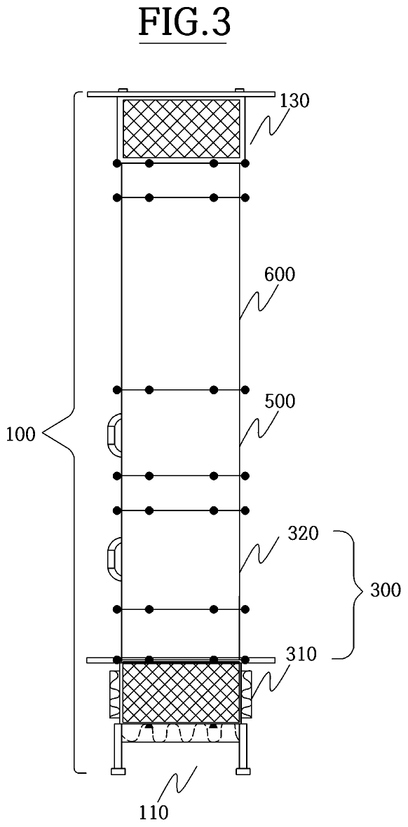

FIG. 1 is a perspective view schematically showing the exterior of a passive apparatus for reducing floating radioactive material in a containment building according to an embodiment. FIG. 2 is a front view of the apparatus shown in FIG. 1. FIG. 3 is a side view of the apparatus shown in FIG. 2. As shown in FIGS. 1 to 3, the passive apparatus for reducing the floating radioactive material in the containment building according to the embodiment includes a housing 100, a radioactive material reduction unit 300, and a flow induction unit 500.

The housing 100 includes an inlet 110 located at a lower end thereof, the inlet being open downward such that air is introduced into the containment building, and an outlet 130 located at an upper end thereof, the outlet being configured to allow processed air to be discharged therethrough. In the embodiment shown, the housing 100 has the overall shape of a square column and constitutes an air passage from the inlet 110 to the outlet 130. The sectional area and length of the housing 100 affects an air flow and thus may be designed according to the amount of radioactive material the reduction apparatus must process or the rate of processing. The material of the housing may be SUS304 or SUS316 stainless steel.

In the embodiment shown, the inlet 110 is located at the lower end of the housing 100 and has a structure that is open in five directions: a forward direction, a backward direction, a leftward direction, a rightward direction, and a downward direction. In contrast, the outlet 130 is located at the upper end of the housing 100 and has a structure that is open in four directions: the forward direction, the backward direction, the leftward direction, and the rightward direction. In the event of a major accident at a nuclear power plant, cooling water is sprayed from a sprinkler system on the ceiling of the containment building. The top of the housing 100 is covered with a wide roof in order to prevent foreign matter, such as the sprayed water, from being introduced into the housing. In addition, each opening of the outlet 130 is covered with a mesh net in order to prevent foreign matter from being introduced into the outlet in a lateral direction.

The radioactive material reduction unit 300 is received in the housing 100 and reduces radioactive material in air introduced through the inlet 110. In an aspect, the radioactive material reduction unit 300 may include an adsorber module 320 filled with an adsorbent configured to adsorb gaseous radioactive material. In an embodiment, the adsorber module 320 reduces elemental iodine or an iodine compound, such as methyl iodide (CH₃I), included in an air flow through physical or chemical adsorption. The adsorbent may be any one of, for example, silver zeolite (AgX), silver nitrate (AgNO₃), or a metal organic framework (MOF)-based material. The adsorbent may be disposed on the surface of an appropriate surface-treated supporting material or substrate.

In an aspect, the flow induction unit 500 is received in the housing 100 and is located downstream of the radioactive material reduction unit 300. The flow induction unit 500 removes hydrogen in the incoming air by catalytic reaction and heats the air using heat generated by the reaction, thereby generating an air flow in a direction from the inlet 110 to the outlet 130 by a so-called chimney effect. The catalytic reaction may additionally induce reaction of another combustible gas such as carbon monoxide.

In FIGS. 2 and 3, components 101 disposed on the surface of the housing are sensor holes and pipes necessary to install various sensors, which are not relevant to the present invention, and therefore a description thereof will be omitted.

In the event of a major accident at a nuclear power plant, nuclear fuel in a nuclear reactor may overheat, and hydrogen may be generated as the result of chemical reaction between a zirconium cladding of a fuel rod and steam. When the hydrogen is discharged from the nuclear reactor into the containment building, the hydrogen may react with oxygen in the air, whereby explosion may occur. A catalyst of the flow induction unit 500 enables hydrogen to react with oxygen, thereby generating steam, even when the hydrogen concentration is low in a low temperature environment. Since reaction begins at the concentration lower than the critical hydrogen concentration required to burn hydrogen in the air, it is possible to prevent explosion in the containment building. In addition, the generated air flow passes through the radioactive material reduction unit 300, whereby passive operation of the passive floating radioactive material reduction apparatus according to the present invention is possible.

The flow induction unit 500 may include a plurality of sheets, plates, or blades each made of a catalytically active material or having a surface coated with catalytically active material. In the embodiment shown, the catalyst may be made of one of platinum (Pt) and palladium (Pd).

### Invention Defined by Claim 3

In an aspect, the adsorber module 320 of the radioactive material reduction unit 300 may have replaceable modular structure that is slidably fastened to the housing 100. As shown in FIGS. 1 to 3, the adsorber module 320 may be configured in the form of a drawer, and may be received in a receiving space open to the front of the housing 100. Accordingly, the adsorbent modules 320 may be easily replaced when the adsorbent is denatured beyond the expiration date thereof.

### Invention Defined by Claim 4

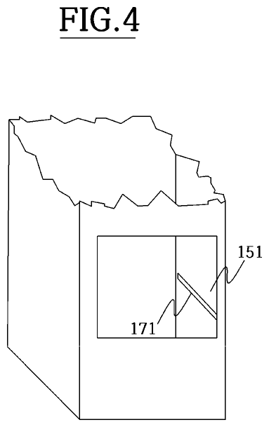

FIG. 4 is a view exemplarily showing the receiving space of the housing in which the adsorber module is slidably received. As shown, the housing 100 includes a first receiving space 151 and a pair of first sliding guides 171. The first receiving space 151 is a space open to one side of the housing, to the front of the housing in this case, which receives the adsorber module 320. Obviously, the first receiving space 151 extends in a vertical direction. Each of the pair of first sliding guides 171 is fixed to a corresponding one of opposite inner walls that face each other, and slidably supports the adsorber module 320. Each of the first sliding guides 171 may be any one of several customary types of mechanical elements found in a chest of drawers.

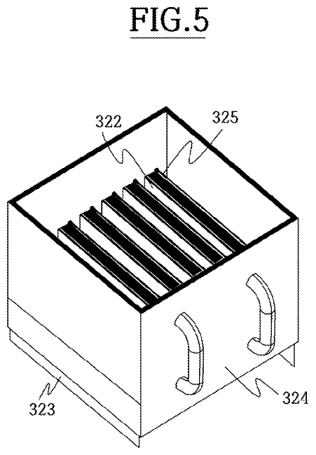

FIG. 5 is a perspective view showing the configuration of an adsorber module according to an embodiment. The adsorber module 320 according to the embodiment includes a first module housing 324 and a pair of first sliders 323. The first module housing 324 is received in the first receiving space 151 of the housing 100, and has a size that fills the first receiving space 151. Each of the pair of first sliders 323 is fixed to a corresponding one of opposite outer walls of the first module housing 324, and is engaged with a corresponding one of the first sliding guides 171 fixed to the opposite inner walls of the housing 100 to slidably support the first module housing 324.

### Invention Defined by Claim 5

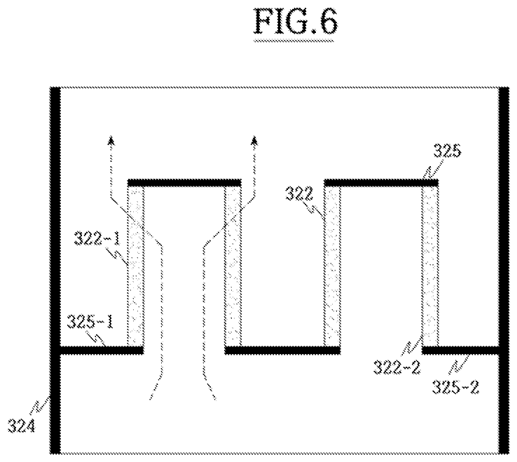

The adsorber module 320 has a reactor structure configured to adsorb gaseous radioactive material, for example, elemental iodine or an iodine compound, such as methyl iodide (CH₃I), therein. The adsorber module 320 corresponds to a flow resistance that interferes with a natural convection flow generated through the flow induction unit 500, and therefore the adsorber module must have a structure configured to reduce the differential pressure in order to generate an appropriate flow. FIG. 6 is a view illustrating an exemplary layout structure of adsorption plates in the adsorber module. In an embodiment, the adsorber module may include a plurality of adsorption plates 322 disposed therein, each of the adsorption plates having a flat shape, wherein the adsorption plates are arranged side by side in an air flow direction while being spaced apart from each other in parallel and are connected to each other in a zigzag fashion.

In an embodiment, the plurality of adsorption plates 322 is disposed in parallel while being spaced apart from each other in the state in which one end of each adsorption plate is connected to one end of an adsorption plate adjacent thereto on one side via a blocking member 325 and the other end of each adsorption plate is connected to the other end of an adsorption plate adjacent thereto on the other side via another blocking member 325. Accordingly, air introduced from upstream enters through a space between the blocking members as indicated by dotted arrows, passes through two adsorption plates 322, and flows in a downstream direction. The inlet area through which the air passes is the area of the space between adjacent blocking members, but the area that reacts with the adsorbent is twice the area of each adsorption plate, whereby it is possible to reduce the differential pressure between upstream and downstream. In the embodiment shown, the spaces between adsorption plates 322-1 and 322-2 located at opposite ends, among the plurality of adsorption plates 322, and the inner wall of the first module housing 324 are blocked by respective blocking members 325-1 and 325-2.

### Invention Defined by Claims 6 and 7

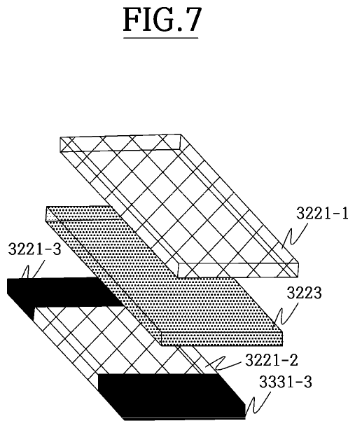

FIG. 7 is a perspective view showing the configuration of an adsorption plate according to an embodiment. As shown, the adsorption plate 322 according to the embodiment may include a first flat mesh housing 3221 and a first bed 3223. In the embodiment shown, the first flat mesh housing 3221 may be constituted by a first upper mesh housing 3221-1 and a first lower mesh housing 3221-2, which are assembled by fastening. The first flat mesh housing 3221 is provided at each of opposite ends thereof with a first support member 3221-3 configured to fix the adsorption plate 322 to the inner wall of the first module housing 324 by fastening. In an embodiment, the first flat mesh housing 3221 is made of stainless steel. In the embodiment shown, the first bed 3223 has a shape that is received in the first flat mesh housing 3221, and is manufactured by fixing an adsorbent to a first porous substrate by impregnation. The first porous substrate may be made of any one of silica gel, activated carbon, activated alumina, and zeolite, and the adsorbent may be made of any one of silver (Ag) and palladium (Pd).

### Invention Defined by Claim 8

In another aspect, the radioactive material reduction unit may further include an aerosol filter fixed to the inlet to remove particulate matter from the incoming air. Referring back to FIGS. 1, 2, and 3, in the embodiment shown, the aerosol filter 310 is installed at the inlet 110 in each of the five directions. The aerosol filter 310 may effectively remove radioactive aerosol particles by removing particulate matter from the air. Additionally, the aerosol filter 310 may remove moisture from the incoming air to increase the lifespan of the adsorbent or the catalyst of the flow induction unit.

### Invention Defined by Claim 9

In an aspect, the flow induction unit 500 may have a replaceable modular structure that is slidably fastened to the housing 100. As shown in FIGS. 1 to 3, the flow induction unit 500 may be configured in the form of a drawer, and may be received in a receiving space open to the front of the housing 100. Accordingly, the flow induction unit 500 may be easily replaced when the catalyst is denatured beyond the expiration date thereof.

### Invention Defined by Claim 10

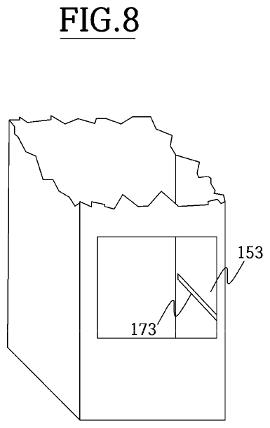

FIG. 8 is view exemplarily showing the receiving space of the housing in which the flow induction unit 500 is slidably received. As shown, the housing 100 includes a second receiving space 153 and a pair of second sliding guides 173. The second receiving space 153 is a space open to one side of the housing, to the front of the housing in this case, which receives the flow induction unit 500. Obviously, the second receiving space 153 extends in the vertical direction. Each of the pair of second sliding guides 173 is fixed to a corresponding one of opposite inner walls that face each other, and slidably supports the flow induction unit 500. Each of the second sliding guides 173 may be any one of several customary types of mechanical elements found in a chest of drawers.

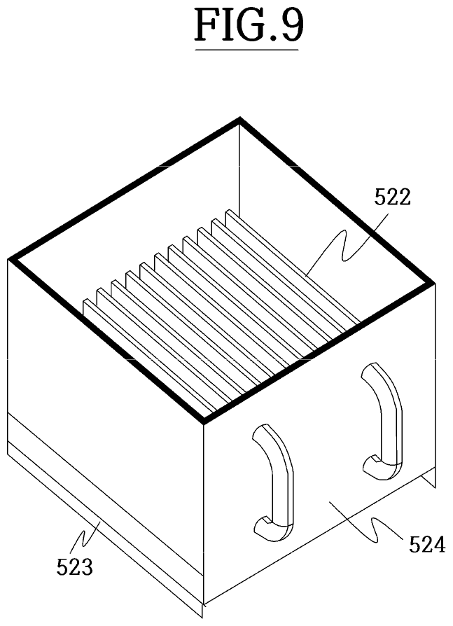

FIG. 9 is a perspective view showing the configuration of a flow induction unit according to an embodiment. The flow induction unit 500 according to the embodiment includes a second module housing 524 and a pair of second sliders 523. The second module housing 524 is received in the second receiving space 153 of the housing 100, and has a size that fills the second receiving space 153. Each of the pair of second sliders 523 is fixed to a corresponding one of opposite outer walls of the second module housing 524, and is engaged with a corresponding one of the second sliding guides 173 fixed to the opposite inner walls of the housing 100 to slidably support the second module housing 524.

### Invention Defined by Claim 11

The flow induction unit 500 must have a structure that reduces the flow resistance while increasing the reaction area. s shown in FIG. 9, in an embodiment, the flow induction unit 500 may include a plurality of catalyst plates 522 disposed therein, each of the catalyst plates having a flat shape, wherein the catalyst plates are arranged side by side in an air flow direction while being spaced apart from each other in parallel. In an embodiment, each of opposite ends of the plurality of catalyst plates 522 is fixed to a corresponding one of opposite inner walls of the second module housing 524. Accordingly, air introduced from upstream passes through the space between the respective catalyst plates 522.

### Invention Defined by Claims 12 and 13

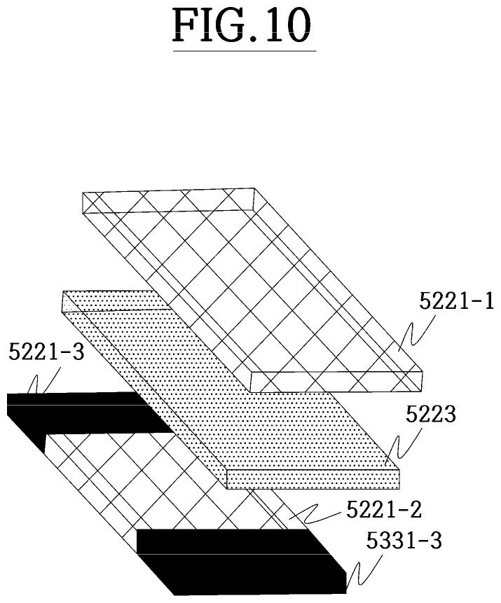

FIG. 10 is a perspective view showing the configuration of a catalyst plate according to an embodiment. As shown, the catalyst plate 522 according to the embodiment may include a second flat mesh housing 5221 and a second bed 5223. In the embodiment shown, the second flat mesh housing 5221 may be constituted by a second upper mesh housing 5221-1 and a second lower mesh housing 5221-2, which are assembled by fastening. The second flat mesh housing 5221 is provided at each of opposite ends thereof with a second support member 5221-3 configured to fix the catalyst plate 522 to the inner wall of the second module housing 524 by fastening. In an embodiment, the second flat mesh housing 5221 is made of stainless steel. In the embodiment shown, the second bed 5223 has a shape that is received in the second flat mesh housing 5221, and is manufactured by fixing a catalyst to a second porous substrate by impregnation. In the embodiment shown, the second porous substrate is made of aluminum oxide (Al₂O₃), and the catalyst is made of platinum (Pt). However, the present invention is not limited thereto. For example, the catalyst may be made of palladium (Pd).

### Invention Defined by Claim 14

The flow induction unit 500 and the adsorber module 320 have advantages and disadvantages depending on the position thereof, and therefore the position of each of the flow induction unit and the adsorber module is determined in consideration thereof and then each of the flow induction unit and the adsorber module is designed. When the adsorber module 320 is located downstream of the flow induction unit 500, combustible gas, such as hydrogen, is directly introduced into the flow induction unit 500, which may be more advantageous for flow induction according to the catalytic reaction, and the temperature of ambient air is increased to remove moisture by heat generated by reaction in the flow induction unit 500, whereby it is possible to prevent the iodine removal performance of the adsorber module 320 from being reduced by moisture. If high-concentration hydrogen is introduced and combustion occurs in the flow induction unit 500, on the other hand, the temperature of the atmosphere may rise rapidly and flames from the combustion may spread, whereby the adsorbent may be affected.

Meanwhile, when the adsorber module 320 is located upstream of the flow induction unit 500, as in the present invention, a poisoning material that interferes with reaction between the flow induction unit 500 and combustible gas may be removed by the flow induction unit 500 in advance, whereby it is possible to reduce a flow induction reduction factor. On the other hand, combustible gas, such as hydrogen or carbon monoxide, may first react with the adsorbent while passing through the adsorber module 320 before reaction with the flow induction unit 500, which may impede flow induction. The present invention improves catalytic reaction efficiency and adsorption efficiency by designing the length and the sectional area of the chimney and the position and the area of the inlet and the outlet in order to achieve an appropriate air flow and by further improving the structure of the flow induction unit 500 or the adsorber module 320.

As is apparent from the above description, according to the present invention, radioactive material reduction apparatus operates instantaneously without the supply of external energy through an air flow induced by catalytic reaction with hydrogen in the event of a major accident and continues to operate for a sufficient time.

In addition, a radioactive material reduction unit is disposed upstream of a flow induction unit such that radioactive material in the incoming air is first removed before entering the flow induction unit, whereby it is possible to prevent poisoning of the catalyst and thus to extend the lifespan of the catalyst. Consequently, it is possible to extend the passive operation time of the radioactive material reduction apparatus.

Furthermore, the reaction area is increased through a flat bed structure to which a catalyst is fixed by impregnation, whereby it is possible for the radioactive material reduction apparatus according to the present invention to generate a strong air flow and to operate for a sufficient time. In addition, an adsorber has a structure in which a plurality of beds, in which an adsorbent is fixed to a porous substrate by impregnation, is arranged side by side in an air flow direction while being spaced apart from each other in parallel and is connected to each other in a zigzag fashion, whereby it is possible to improve gaseous radioactive material adsorption efficiency. Furthermore, an aerosol filter added to an inlet not only removes particulate radioactive material but also removes moisture from the air, whereby it is possible to prevent reduction in the adsorption efficiency of the flow induction unit due to moisture and thus to prevent weakening of the flow.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A passive apparatus for reducing floating radioactive material in a containment building, the apparatus comprising:
a housing comprising an inlet located at a lower end thereof, the inlet being open downward such that air is introduced into the containment building, and an outlet located at an upper end thereof, the outlet being configured to allow processed air to be discharged therethrough, the housing constituting an air passage from the inlet to the outlet;
a radioactive material reduction unit received in the housing, the radioactive material reduction unit being configured to reduce radioactive material in air introduced through the inlet; and
a flow induction unit received in the housing, the flow induction unit being located downstream of the radioactive material reduction unit, the flow induction unit being configured to remove hydrogen in incoming air by catalytic reaction and to form an air flow in a direction from the inlet to the outlet using heat generated by the reaction.

2. The apparatus according to claim 1, wherein the radioactive material reduction unit comprises an adsorber module filled with an adsorbent configured to adsorb gaseous radioactive material.

3. The apparatus according to claim 2, wherein the adsorber module has a replaceable modular structure that is slidably fastened to the housing.

4. The apparatus according to claim 3, wherein
the housing comprises: a first receiving space open to one side; and a pair of first sliding guides each fixed to a corresponding one of opposite inner walls that face each other, the first sliding guides being configured to slidably support the adsorber module, and
the adsorber module comprises: a first module housing received in the first receiving space, the first module housing having a size that fills the first receiving space of the housing; and a pair of first sliders each fixed to a corresponding one of opposite outer walls of the first module housing, each of the first sliders being engaged with a corresponding one of the first sliding guides, the first sliders being configured to slidably support the first module housing.

5. The apparatus according to claim 2, wherein the adsorber module comprises a plurality of adsorption plates disposed therein, each of the adsorption plates having a flat shape, the adsorption plates being arranged side by side in an air flow direction while being spaced apart from each other in parallel and being connected to each other in a zigzag fashion.

6. The apparatus according to claim 5, wherein each adsorption plate comprises:
a first flat mesh housing surrounded by a mesh; and
a first bed having a shape that is received in the first flat mesh housing, the first bed being configured such that an adsorbent is fixed to a first porous substrate by impregnation.

7. The apparatus according to claim 6, wherein
the first porous substrate is made of any one of silica gel, activated carbon, activated alumina, and zeolite, and
the adsorbent is made of any one of silver (Ag) and palladium (Pd).

8. The apparatus according to claim 2, wherein the radioactive material reduction unit further comprises an aerosol filter fixed to the inlet, the aerosol filter being configured to remove particulate matter from the incoming air.

9. The apparatus according to claim 1, wherein the flow induction unit has a replaceable modular structure that is slidably fastened to the housing.

10. The apparatus according to claim 9, wherein
the housing comprises: a second receiving space open to one side; and a pair of second sliding guides each fixed to a corresponding one of opposite inner walls that face each other, the second sliding guides being configured to slidably support the flow induction unit, and
the flow induction unit comprises: a second module housing received in the second receiving space, the second module housing having a size that fills the second receiving space of the housing; and a pair of second sliders each fixed to a corresponding one of opposite outer walls of the second module housing, each of the second sliders being engaged with a corresponding one of the second sliding guides, the second sliders being configured to slidably support the second module housing.

11. The apparatus according to claim 1, wherein the flow induction unit comprises a plurality of catalyst plates disposed therein, each of the catalyst plates having a flat shape, the catalyst plates being arranged side by side in an air flow direction while being spaced apart from each other in parallel.

12. The apparatus according to claim 11, wherein each catalyst plate comprises:
a second flat mesh housing surrounded by a mesh; and
a second bed having a shape that is received in the second flat mesh housing, the second bed being configured such that a catalyst is fixed to a second porous substrate by impregnation.

13. The apparatus according to claim 12, wherein
the second porous substrate is made of aluminum oxide (Al₂O₃), and
the catalyst is made of one of platinum (Pt) and palladium (Pd).
